(19) United States
(12) Patent Application Publication
(10) Pub. No.: US 2018/0188590 A1
(43) Pub. Date: Jul. 5, 2018

(54) TOUCH DISPLAY SCREEN AND METHOD FOR MANUFACTURING THE SAME, TOUCH DISPLAY DEVICE

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Honggang GU, Beijing (CN); Xianjie SHAO, Beijing (CN); Jie SONG, Beijing (CN); Yimin CHEN, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/805,997

(22) Filed: Nov. 7, 2017

(30) Foreign Application Priority Data
Jan. 5, 2017 (CN) 201710007116.1

(51) Int. Cl. G02F 1/1335; G02F 1/1333; G06F 3/041

(52) U.S. Cl. CPC G02F 1/133504; G02F 1/13338; G02F 1/133512; G06F 2203/04103; G06F 3/0412; G02F 2001/133507; G02F 2001/133562; G02F 1/133514

(57) ABSTRACT

The present disclosure provides a touch display screen and a method for manufacturing the same as well as a touch display device. The touch display screen includes a black matrix pattern, a touch electrode layer, and a light converting layer. The light converting layer is between the black matrix pattern and the touch electrode layer and is configured to convert diffracted light rays that pass through the black matrix pattern into parallel light rays which pass through the touch electrode layer to emit from the touch display screen.

### CROSS-REFERENCE TO RELATED APPLICATION

This application claims priority to Chinese Patent Application No. 201710007116.1 filed on Jan. 5, 2017, which is incorporated herein by reference in its entirety.

### TECHNICAL FIELD

The present disclosure relates to the field of touch display technologies, and in particular to a touch display screen and a method for manufacturing the same, and a touch display device.

### BACKGROUND

With development of touch display technology, touch display devices are widely used for displays. Common touch display devices include smart phones, tablet computers, intelligent vehicle terminals and so on.

One touch display device generally includes a backlight source and a touch display screen. In the related art, the touch display screen includes a display panel which includes a cell defined by an array substrate and a color filter substrate, and a liquid crystal layer between the array substrate and the color filter substrate. The touch display screen further includes a touch electrode layer. The color filter substrate includes a base substrate and a black matrix pattern on the base substrate. The touch electrode layer is disposed on one surface of the base substrate of the color filter substrate facing away from the liquid crystal layer. The touch electrode layer includes a touch electrode pattern which is composed of a plurality of touch electrodes arranged in a matrix. When the touch display device works, light rays emitted from the backlight source are able to pass through the array substrate, the liquid crystal layer, the color filter substrate and the touch electrode layer in turn and emit from the touch display screen.

In the process of realizing the present disclosure, the inventor discovers that there are at least the following problems in the related art:

When light rays pass through the touch display screen, the light rays are distracted and interfered by the black matrix pattern and then enter into the touch electrode layer. Light rays that enter into the touch electrode layer will be distracted and interfered again by the touch electrode pattern. Thus, the light rays undergoing two superimposed diffraction and interference before emitting from the touch display screen, and thus visible undesirable moiré patterns easily appear on the touch display screen.

### SUMMARY

In order to solve the problem of appearance of the visible undesirable moiré patterns on the touch display screen in the related art, the present disclosure provides a touch display screen and a method for manufacturing the same as well as a touch display device. The technical solutions are as follows.

According to a first aspect, a touch display screen is provided and includes a black matrix pattern, a touch electrode layer and a light converting layer. The light converting layer is between the black matrix pattern and the touch electrode layer and is configured to convert diffracted light rays that pass through the black matrix pattern into parallel light rays which pass through the touch electrode layer to emit from the touch display screen.

Further, the touch display screen further includes a color filter substrate. The color filter substrate includes a base substrate, and the black matrix pattern and a color filter layer in opening regions of the black matrix pattern.

Further, the black matrix pattern and the color filter layer are on an identical side of the base substrate. The touch electrode layer is on one side of the base substrate facing away from the black matrix pattern.

Further, the light converting layer is between the base substrate and the black matrix pattern, and the black matrix pattern is between the light converting layer and the color filter layer. Or, the light converting layer is between the base substrate and the color filter layer, and the color filter layer is between the light converting layer and the black matrix pattern.

Further, the light converting layer is between the base substrate and the touch electrode layer.

Further, the touch electrode layer, the black matrix pattern and the color filter layer are at one side of the base substrate facing away from a light emitting surface of the touch display screen, and the touch electrode layer is between the base substrate and the light converting layer.

Further, the color filter layer is at one side of the base substrate, the touch electrode layer, the light converting layer and the black matrix pattern are at one side of the base substrate facing away from the color filter layer, and the black matrix pattern is between the base substrate and the light converting layer.

Further, the light converting layer includes prim structures which are configured to convert the distracted light rays that pass through the black matrix pattern into parallel light rays which are perpendicular to a light emitting surface of the touch display screen.

According to a second aspect, a method for manufacturing a touch display screen is provided and includes: forming a black matrix pattern, a touch electrode layer and a light converting layer in such a manner that the light converting layer is between the black matrix pattern and the touch electrode layer. The light converting layer is configured to convert diffracted light rays that pass through the black matrix pattern into parallel light rays which pass through the touch electrode layer to emit from the touch display screen.

Further, the touch display screen includes a color filter substrate; the color filter substrate includes a base substrate, the black matrix pattern and a color filter layer in opening regions of the black matrix pattern.

Further, forming a black matrix pattern, a touch electrode layer and a light converting layer in such a manner that the light converting layer is disposed between the black matrix pattern and the touch electrode layer includes: forming the light converting layer at one side of the base substrate; forming the black matrix pattern and the color filter layer on the light converting layer in such a manner that the color filter layer is in the opening regions of the black matrix pattern; and forming the touch electrode layer on one side of the base substrate facing away from the black matrix pattern.

Further, forming a black matrix pattern, a touch electrode layer and a light converting layer in such a manner that the light converting layer is disposed between the black matrix pattern and the touch electrode layer includes: forming the black matrix pattern and the color filter layer on one side of the base substrate in such a manner that the color filter layer is in the opening regions of the black matrix pattern; forming the light converting layer on one side of the base substrate facing away from the black matrix pattern; and forming the touch electrode layer on the light converting layer.

Further, forming a black matrix pattern, a touch electrode layer and a light converting layer in such a manner that the light converting layer is disposed between the black matrix pattern and the touch electrode layer includes: forming the touch electrode layer on one side of the base substrate; forming the light converting layer on the touch electrode layer; and forming the black matrix pattern and the color filter layer on the light converting layer in such a manner that the color filter layer is in the opening regions of the black matrix pattern.

Further, forming a black matrix pattern, a touch electrode layer and a light converting layer in such a manner that the light converting layer is disposed between the black matrix pattern and the touch electrode layer includes: forming the color filter layer on one side of the base substrate; and forming the touch electrode layer, the light converting layer and the black matrix pattern on one side of the base substrate facing away from the color filter layer in such a manner that the black matrix pattern is between the base substrate and the light converting layer.

According to a third aspect, a touch display device is provided and includes the touch display screen according to the first aspect.

The benefit effects of the technical solutions of the present disclosure at least include the following: according to the touch display screen and the method for manufacturing the same as well as the touch display device, since the light converting layer is able to convert diffracted light rays that pass through the black matrix pattern into parallel light rays, the light converting layer can prevent the light from undergoing two superimposed diffraction and interference before emitting from the touch display screen, thereby avoiding appearance of the visible undesirable moiré patterns on the touch display screen, solving the problem of appearance of the visible undesirable moiré patterns on the touch display screen in the related art, and then achieving effects of avoiding appearance of the visible undesirable moiré patterns on the touch display screen.

It should be understood that the above general description and the following detailed description are merely exemplary, are not intended to limit the scope of the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1-1 is a schematic diagram of a touch display screen in the related art;

FIG. 1-2 is a schematic diagram showing that the light diffraction and light interference occurring at the touch display screen shown in FIG. 1-1;

FIG. 1-3 is a schematic view of one visual pattern shown on the touch display screen when light only passes a touch electrode layer of the touch display screen shown in FIG. 1-1;

FIG. 1-4 is a schematic view of one visual pattern shown on the touch display screen when light only passes a black matric pattern of the touch display screen shown in FIG. 1-1;

FIG. 1-5 is a schematic view of a moiré pattern obtained by superimposing the pattern shown in FIG. 1-3 and the pattern shown in FIG. 1-4;

FIG. 1-6 is a schematic view of a moiré pattern in the related art;

FIG. 1-7 is a schematic view of another moiré pattern in the related art;

FIG. 2 is a schematic view of a touch display screen according to an embodiment of the present disclosure;

FIG. 3 is a schematic view of a touch display screen according to another embodiment of the present disclosure;

FIG. 4 is a schematic view of a touch display screen according to still another embodiment of the present disclosure;

FIG. 5 is a schematic view of a touch display screen according to yet another embodiment of the present disclosure;

FIG. 6 is a schematic view of a touch display screen according to still yet another embodiment of the present disclosure;

FIG. 7 is a schematic view of a touch display screen according to still yet another embodiment of the present disclosure;

FIG. 8 is a schematic diagram showing that light diffraction and light interference occurring at the touch display screen according to an embodiment of the present disclosure;

FIG. 9 is a schematic view of a display device which includes the touch display screen according to an embodiment of the present disclosure;

FIG. 10-1 is a flow chart of a method for manufacturing a touch display screen according to an embodiment of the present disclosure;

FIG. 10-2 is a schematic view showing a structure obtained by forming a black matrix pattern and a color filter layer on one side of a base substrate of a color filter substrate according to the embodiment shown in FIG. 10-1;

FIG. 10-3 is a schematic view of a structure obtained by form an alignment layer on one side of the base substrate of the color substrate where the black matrix pattern and the color filter layer are formed according to the embodiment in FIG. 10-1;

FIG. 10-4 is a schematic view of a structure obtained by forming a light converting layer on one side of the base substrate of the color filter substrate facing away from the black matrix pattern according to the embodiment in FIG. 10-1;

FIG. 10-5 is a schematic view of a structure obtained by forming a touch electrode layer on the light converting layer according to the embodiment in FIG. 10-1;

FIG. 10-6 is a schematic view of an array substrate according to the embodiment in FIG. 10-1;

FIG. 10-7 is a schematic view of a structure obtained by oppositely arranging the array substrate with respect to the color filter substrate to define a cell according to the embodiment in FIG. 10-1; and

FIG. 10-8 is a schematic view of a structure obtained by forming a first polarizer on the touch electrode layer according to the embodiment in FIG. 10-1.

The above drawings have shown embodiments of the present disclosure which will be described in detail in the following. The drawings and description are not intended to limit the scope of conception of the present disclosure in any way, but serve to explain the principles of the disclosure.

### DETAILED DESCRIPTION

In order to make the objects, the technical solutions and the advantages of the present disclosure more apparent, the present invention will be described hereinafter in conjunction with the drawings. Obviously, the followings are merely a part of, rather than all of, the embodiments, and the other embodiments obtained by a person skilled in the art based on these embodiments, without any creative effort, shall also fall within the scope of the present invention.

Drivers of thin film transistor liquid crystal display (TFT-LCD) device mainly include a data driver and a gate driver. Currently, there are two types of the gate driver. One is a chip on glass (COG), an integrated circuit (IC) of COG is connected with a gate lead wire, a signal is input to a gate electrode of a thin film transistor (TFT) through the IC and the gate lead wire, thereby realizing scanning of each pixel. Another one is to connect each gate line to one circuit unit of a shift register, input a signal to the gate electrode of the TFT through a gate driving circuit to scan each pixel line by line. The gate driving circuit may be divided into a bilateral drive circuit and a cross driving circuit according to driving modes. The gate driving circuit may be divided into a unidirectional scanning circuit and a bidirectional scanning circuit according to scanning directions. For a liquid crystal display panel, gate driver on array circuit may reduce cost of products, save a process and increase production capacity.

With development of touch display technology, touch display screens (which are also referred as touch panels) are widely used in people's life. The widespread use of the touch display screens, as input devices, causes input devices in the past to be gradually eliminated. Currently, a variety of input devices may be applied to a computer system to perform input operations, for example, the input devices include a mouse, a button, a touch panel, a joystick, a touch display screen and so on. The touch display screen has ease of use and versatility of operation, and the price of the touch display screen is also declining, and the yield is steadily improving, which make the touch display screen more and more popular.

The touch display screens may be divided into an add on mode touch display screen and an in-cell touch display screen. In the add on mode touch display screen, a touch panel with a touch function is positioned in front of a display device, and a surface of the touch panel covers a display region of the display device, thereby realizing the touch function. In the in-cell touch display screen, a touch panel with a touch function is integrated with a display panel, and a cover glass is attached to an outer surface of the touch panel or no cover glass is attached to the outer surface of the touch panel, and then one user may touch the touch panel with fingers to realize the touch function. The in-cell touch display screen may also be divided into an in cell touch display screen and an on cell touch display screen. In the on cell touch display screen, a touch electrode (which is also referred as induction electrode) is formed on an outside of a display panel, and then a polarizer and a cover glass and so on are attached to the touch electrode. In a hybrid in cell touch display screen or full in cell touch display screen, a touch electrode may be formed at one side of a TFT glass (i.e., an array substrate) or one side of the TFT glass and a color filter (CF), and then is made into the touch display screen to realize the touch function.

A black matrix (BM) pattern and a touch electrode pattern in a liquid crystal display (LCD) device are two periodic graphics. Superposition of periodic graphics cause light rays to undergo two superimposed diffraction and interference, resulting in a visible periodic graphic appearing on the touch display screen with a period different from each of the periods of the BM pattern and the touch electrode pattern. This visible periodic graphic is referred as Moire pattern.

A diffraction system is generally composed of a light source, a diffraction screen and a receiving screen. According to distance relationship among the light source, the diffraction screen and the receiving screen, the diffraction system is generally divided into two kinds: one is Fresnel diffraction system in which a distance between the diffraction screen and each of the light source and the receiving screen is finite under spherical wave illumination; and the other one is Fraunhofer diffraction system in which a distance between the diffraction screen and each of the light source and the receiving screen is infinite under plane wave illumination.

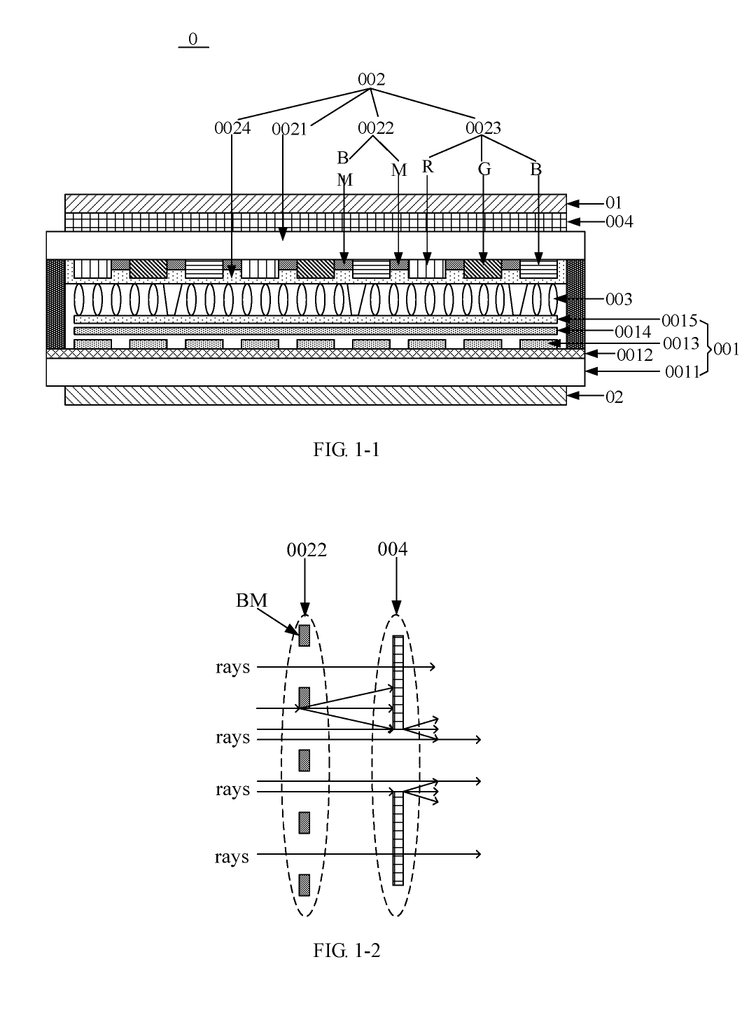

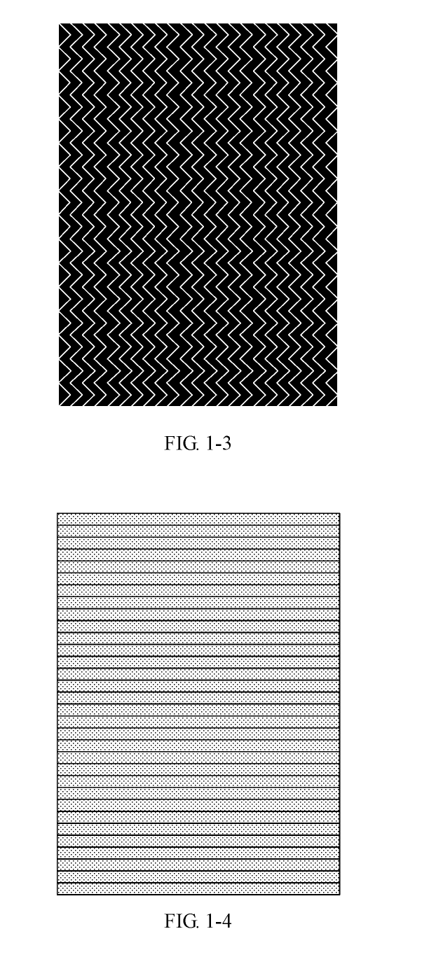

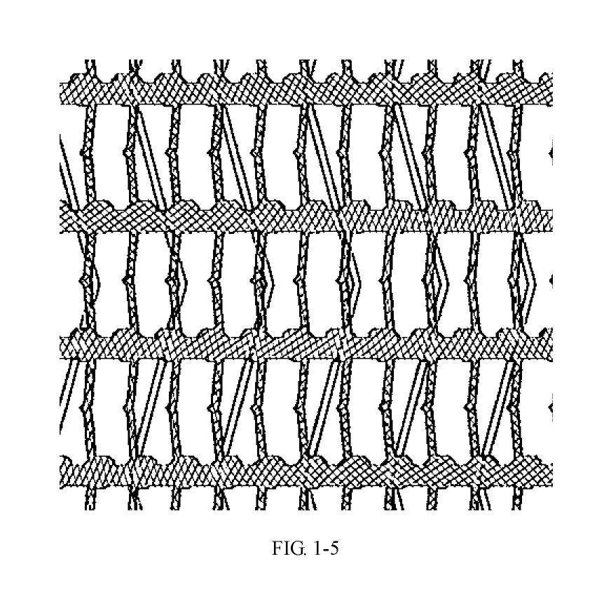

FIG. 1-1 is a schematic diagram of a touch display screen 0 in the related art. Referring to FIG. 1-1, the touch display screen 0 includes a display panel (not labeled in FIG. 1), a first polarizer 01 disposed at a light emitting surface (not labeled in FIG. 1) of the display panel, and a second polarizer 02 disposed at a light incident surface (not labeled in FIG. 1) of the display panel. The display panel includes an array substrate 001, a color substrate 002, a liquid crystal layer 003 between the array substrate 001 and the color substrate 002, and a touch electrode layer 004. The array substrate 001 and the color substrate 002 are oppositely arranged with respect to each other to define a cell. The array substrate 001 includes a first base substrate 0011, and a metal wiring layer 0012, first electrodes 0013, a second electrode 0014 and an alignment layer 0015. The metal wiring layer 0012, the first electrodes 0013, the second electrode 0014 and the alignment layer 0015 are sequentially arranged on a surface of the first base substrate 0011, which is adjacent the liquid crystal layer 003. The color substrate 002 includes a second base substrate 0021, a black matrix pattern 0022, a color filter layer 0023 and an alignment layer 0024. The black matrix pattern 0022, the color filter layer 0023 and the alignment layer 0024 are sequentially arranged on a surface of the second base substrate 0021, which is adjacent the liquid crystal layer 003. The touch electrode layer 004 is disposed at one surface of the second base substrate 0021, which faces away from the liquid crystal layer 003. The touch electrode layer 004 includes a touch electrode pattern (not shown in FIG. 1) which is composed of a plurality of touch electrodes (not shown in FIG. 1) arranged in a matrix.

The black matrix pattern 0022 is a network structure including opening regions. The black matrix pattern 0022 is composed of crisscrossed black matrices. The color filter layer 0023 includes a color filter pattern composed of a plurality of color filter units which are arranged in an array, and the color filter layer 0023 is in the opening regions (not labeled in FIG. 1-1) of the black matrix pattern 0022. For example, one black matrix BM is disposed between any two adjacent color filter units. The color filter units may include red color filter units R, green color filter units G and blue color filter units B. The first electrodes 0013 are block electrodes, and the second electrode 0014 is a plate electrode. One of the first electrode 0013 and the second electrode 0014 is used as a common electrode, and the other one of the first electrode 0013 and the second electrode 0014 is used as a pixel electrode. For example, the first electrode 0013 is used as a pixel electrode, and the second electrode 0014 is used as a common electrode. Each of the alignment layer 0015 and the alignment layer 0024 may be an alignment film.

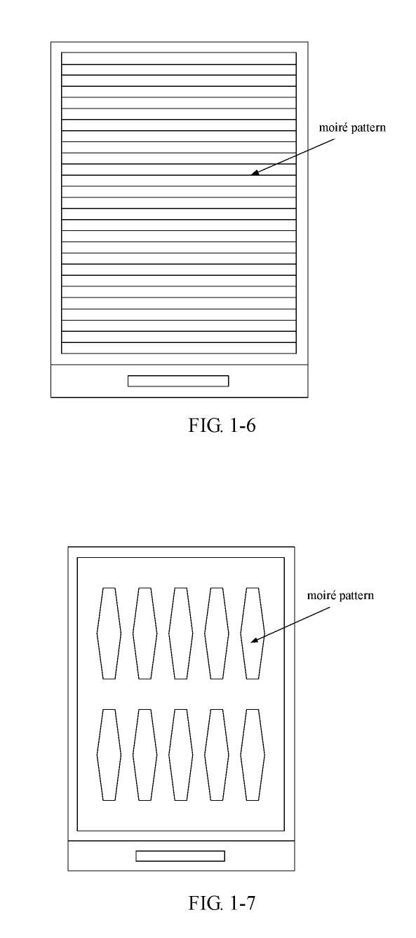

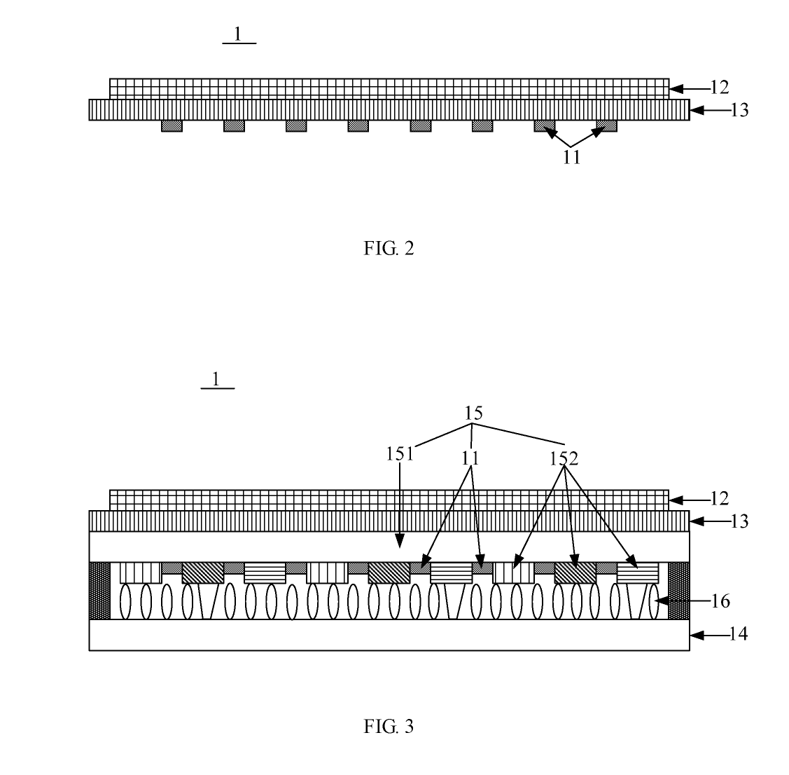

In the touch display screen 0 shown in FIG. 1-1, each of the black matrix pattern 0022 and the touch electrode pattern is a periodic graphic, and each of the black matrix pattern 0022 and the touch electrode pattern may cause occurrence of diffraction and interference of light rays when the light rays are incident to the touch display screen 0 from the light incident surface (not labeled in FIG. 1). Further, after occurrence of diffraction and interference of the light rays, the light rays will be superimposed. As a result, visible undesirable moiré patterns appear at the touch display screen 0. Specifically, as shown in FIG. 1-2, when light rays pass through the black matrix pattern 0022, the black matrices BM can block the light rays, but the light rays may pass through the black matrix pattern 0022 through the opening regions (which are provided with the color filter units therein) of the black matrix pattern. Light rays which pass through the black matrix pattern at a position close to an end of the black matrix BM, are diffracted and change their previous direction. Since the diffracted light rays change their direction, the diffracted light rays will interfere with light rays that are not diffracted. Light rays that undergo interference are then incident to the touch electrode layer 004. The light rays that undergo interference will be diffracted and interfered for another time by the touch electrode pattern of the touch electrode layer 004. Thus, when the light rays pass through the touch display screen 0, the light rays undergo two superimposed diffraction and interference, which results in visible Moire patterns appearing at the touch display screen 0. The principle of appearance of the visible undesirable Moire patterns is described hereinafter in conjunction with FIG. 1-3 to FIG. 1-5.

When light rays only pass the black matrix pattern but do not pass through the touch electrode pattern, one visual pattern shown on the touch display screen 0 is shown in FIG. 1-3. When light rays only pass the touch electrode pattern but do not pass through the black matrix pattern, one visual pattern shown on the touch display screen 0 is shown in FIG. 1-4. When light rays pass the black matrix pattern and the touch electrode pattern in turns, one visual pattern shown on the touch display screen 0 is shown in FIG. 1-5. In FIG. 1-3 and FIG. 1-4, a period of the visual pattern is a period of light rays for undergoing diffraction and interference for one time, and this period is relative small and is imperceptible to human eyes. In FIG. 1-5, a period of the visual pattern is a sum of periods of light rays for undergoing diffraction and interference for two times, and this period is relative large and is perceptible to human eyes, thereby causing appearance of the visible undesirable moiré patterns on the touch display screen 0. FIG. 1-5 is an enlarged view of a portion of a pattern obtained by superimposing the pattern shown in FIG. 1-3 and the pattern shown in FIG. 1-4. The moiré pattern may be shown FIG. 1-5.

The moiré pattern shown FIG. 1-5 is just exemplary. In actual application, the moiré pattern may be varied. The moiré pattern is related to the period of interference and diffraction. For example, the moiré pattern may also be as shown in FIG. 1-6 or FIG. 1-7, which will not be elaborated herein.

For solving the problem of appearance of the visible undesirable moiré patterns on the touch display screen, embodiments of the present disclosure provide a touch display screen and a method for manufacturing the same, and a touch display device, in which a light converting layer is disposed between a black matrix pattern and a touch electrode layer and thereby solving the problem of appearance of the visible undesirable moiré patterns on the touch display screen. The touch display screen and the method for manufacturing the same and the touch display device will be described in detail hereinafter in conjunction with the following embodiments.

FIG. 2 is a schematic view of a touch display screen 1 according to an embodiment of the present disclosure. Referring to FIG. 2, the touch display screen 1 includes a black matrix pattern 11, a touch electrode layer 12 and a light converting layer 13. The light converting layer 13 is disposed between the black matrix pattern 11 and the touch electrode layer 12, and is used to convert diffracted light rays that pass through the black matrix pattern 11 into parallel light rays. The parallel light rays pass through the touch electrode layer 12 and are emitted from the touch display screen 1.

In conclusion, in the touch display screen of one embodiment of the present disclosure, since the light converting layer is able to convert diffracted light rays that pass through the black matrix pattern into parallel light rays, the light converting layer can prevent the light from undergoing two superimposed diffraction and interference before emitting from the touch display screen, thereby solving the problem of appearance of the visible undesirable moiré patterns on the touch display screen in the related art, and then achieving effects of avoiding appearance of the visible undesirable moiré patterns on the touch display screen.

FIG. 3 is a schematic view of a touch display screen 1 according to another embodiment of the present disclosure. Referring to FIG. 3, the touch display screen 1 includes a black matrix pattern 11, a touch electrode layer 12 and a light converting layer 13. The light converting layer 13 is disposed between the black matrix pattern 11 and the touch electrode layer 12, and is used to convert diffracted light rays that pass through the black matrix pattern 11 into parallel light rays. The parallel light rays pass through the touch electrode layer 12 and are emitted from the touch display screen 1.

The touch electrode layer 12 includes a touch electrode pattern (not shown in FIG. 3) which is composed of a plurality of touch electrodes arranged in a matrix. The touch electrodes may include touch-emitting electrodes and touch-receiving electrodes. The touch electrodes may be strip electrodes, or bar electrodes or the like, which are not specifically limited. Optionally, as shown in FIG. 3, the touch display screen 1 includes an array substrate 14, a color substrate 15, and a liquid crystal layer 16 between the array substrate 14 and the color substrate 15. The array substrate 14 and the color substrate 15 are oppositely arranged with respect to each other to define a cell. The color substrate 15 includes a base substrate 151, a black matrix pattern 11 and a color filter layer 152 disposed in opening regions of the black matrix pattern 11.

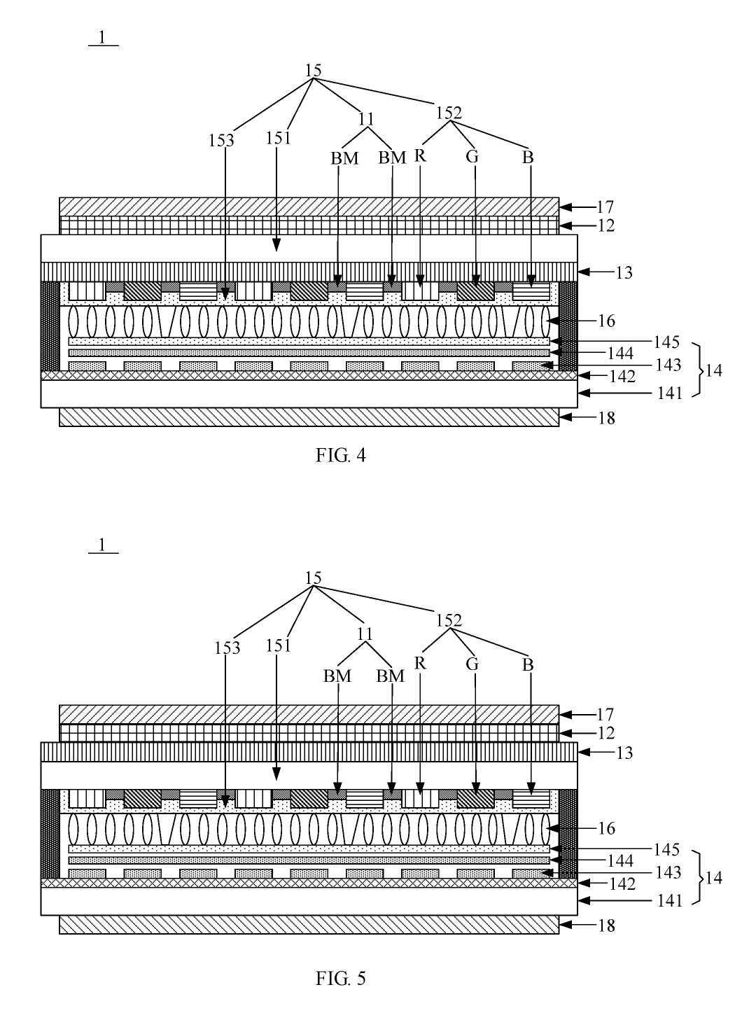

Optionally, FIG. 4 to FIG. 7 are schematic views of another four examples of the touch display screen 1 according to embodiments of the present disclosure. As shown in FIG. 4 to FIG. 7, a sealant frame (not labeled in FIG. 4 to FIG. 7) is disposed between the array substrate 14 and the color filter substrate 15. Liquid crystals are in a spaced enclosed by the sealant frame. A first polarizer 17 is disposed at one side of the color filter substrate 15 facing away from the liquid crystal layer 16. A second polarizer 18 is disposed at one side of the array substrate 14 facing away from the liquid crystal layer 16. A polarization direction of the first polarizer 17 may be perpendicular to a polarization direction of the second polarizer 18, thereby enabling light rays to be able to pass through the touch display screen 1. The liquid crystal layer 16 may include liquid crystals and cylindrical spacers (not labeled in FIG. 4 to FIG. 7) for supporting the array substrate 14 and the color filter substrate 15. The liquid crystals are in a space supported by the cylindrical spacers.

Optionally, as shown in FIG. 4 to FIG. 7, the array substrate 14 includes a base substrate 141, a metal wiring layer 142, first electrodes 143, a second electrode 144 and an alignment layer 145. The metal wiring layer 142, the first electrodes 143, the second electrode 144 and the alignment layer 145 are sequentially arranged on a surface of the base substrate 141, which is adjacent the liquid crystal layer 16. The color substrate 15 includes a base substrate 151, a black matrix pattern 11, a color filter layer 152 and an alignment layer 153. The black matrix pattern 11 is a network structure which is composed of crisscrossed black matrices BM. The color filter layer 152 includes a color filter pattern composed of a plurality of color filter units which are arranged in an array, and the color filter layer 152 is in the opening regions (not labeled in FIG. 4 to FIG. 7) of the black matrix pattern 11. For example, one black matrix BM is disposed between any two adjacent color filter units. As shown in FIG. 4 to FIG. 7, the color filter units may include red color filter units R, green color filter units G and blue color filter units B. The number of each type of the color filter units may be more than one. Each of FIG. 4 to FIG. 7 shows three red color filter units R, three green color filter units G and three blue color filter units B. It should be noted, one embodiment of the present disclosure takes the red color filter units R, the green color filter units G and the blue color filter units B as an example for illustration. In actual application, the color filter layer 152 may further includes color filter units of other color, or may include any two of the red color filter units R, the green color filter units G and the blue color filter units B, which is not specifically limited herein.

Optionally, in one embodiment of the present disclosure, each of the base substrate 151 and the base substrate 141 is a transparent substrate, and may be made of non-metallic transparent material with a certain solidity, such as glass, quartz, transparent resin. The metal wiring layer 142 includes metals wires such as gate lines, data lines and peripheral signal lines. The specific metal wires in the metal wiring layer 142 may refer to the relevant technologies. Each of the first electrode 143 and the second electrode 144 may be a transparent electrode, and may be made of semiconductor oxide such as indium tin oxide (ITO) and indium zinc oxide (IZO), so that the first electrode 143 and the second electrode 144 have good conductivity. In one embodiment of the present disclosure, one of the first electrode 143 and the second electrode 144 is used as a common electrode, and the other of the first electrode 143 and the second electrode 144 is used as a pixel electrode. For example, the first electrode 143 is used as a pixel electrode, and the second electrode 144 is used as a common electrode. The first electrode 143 and the second electrode 144 may have the same shape or have different shapes. For example, as shown in FIG. 4 to FIG. 7, the first electrode 143 is a strip electrode or a point electrode, and the second electrode 144 is a plate electrode. The first electrode 143 may be a point transparent electrode, and the second electrode 144 may be a transparent common electrode. Each of the alignment layer 145 and the alignment layer 153 may be an alignment film which is formed by using a polyimide solution. The color filer unit is used to filter light rays to enable light rays of corresponding colors to pass through the color filer layer 152. The black matrix BM in the black matrix pattern 11 is used to block light rays to avoid light leakage. Each of the color filter unit and the black matrix pattern 11 may be made of resin. For example, the red color filer unit R may be made of red resin material, and is used to enable light rays of red to pass through the color filter layer 152. The green color filer unit G may be made of green resin material, and is used to enable light rays of green to pass through the color filter layer 152. The blue color filer unit B may be made of blue resin material, and is used to enable light rays of blue to pass through the color filter layer 152. The black matrix pattern 11 may be made of black resin material. It should be noted that, the array substrate 14, the black matrix pattern 11 and the color filter layer 152 are described simply, and specific structures of the array substrate 14, the black matrix pattern 11 and the color filter layer 152 may refer to relevant technologies, which will not be elaborated herein.

Optionally, in one embodiment of the present disclosure, as shown in FIG. 4, the black matrix pattern 11 and the color filter layer 152 are disposed at an identical side of the base substrate 151; the touch electrode layer 12 is disposed at one side of the base substrate 151 facing away from the black matrix pattern 11; the light converting layer 13 is disposed between the base substrate 151 and the black matrix pattern 11; the black matrix pattern 11 is disposed between the light converting layer 13 and the color filter layer 152, and the alignment layer 153 is disposed on the touch electrode layer 12. Alternatively, the black matrix pattern 11 and the color filter layer 152 are disposed at an identical side of the base substrate 151; the touch electrode layer 12 is disposed at one side of the base substrate 151 facing away from the black matrix pattern 11; the light converting layer 13 is disposed between the base substrate 151 and the color filter layer 152; the color filter layer 152 is disposed between the light converting layer 13 and the black matrix pattern 11, and the alignment layer 153 is disposed on the black matrix pattern 11. It should be noted that, as shown in FIG. 4, the light converting layer 13, the black matrix pattern 11 and the color filter layer 152 are located at one side of the base substrate 151 adjacent the liquid crystal layer 16, the touch electrode layer 12 is located at one side of the base substrate 151 facing away from the liquid crystal layer 16, and the first polarizer 17 is disposed on the touch electrode layer 12, which are not specifically limited.

Optionally, in one embodiment of the present disclosure, as shown in FIG. 5, the black matrix pattern 11 and the color filter layer 152 are disposed at an identical side of the base substrate 151; the touch electrode layer 12 is disposed at one side of the base substrate 151 facing away from the black matrix pattern 11; the light converting layer 13 is disposed between the base substrate 151 and the touch electrode layer 12, and the first polarizer 17 is disposed on the touch electrode layer 12. In the touch display screen 1 shown in FIG. 5, the black matrix pattern 11 may be located between the base substrate 151 and the color filter layer 152, and the alignment layer 153 is disposed on the color filter layer 152; alternatively, the color filter layer 152 may be located between the base substrate 151 and the black matrix pattern 11, and the alignment layer 153 is disposed on the black matrix pattern 11. It should be noted that, as shown in FIG. 5, the black matrix pattern 11 and the color filter layer 152 are located at one side of the base substrate 151 adjacent the liquid crystal layer 16, the light converting layer 13 and the touch electrode layer 12 are located at one side of the base substrate 151 facing away from the liquid crystal layer 16, and the first polarizer 17 is disposed on the touch electrode layer 12, which are not specifically limited.

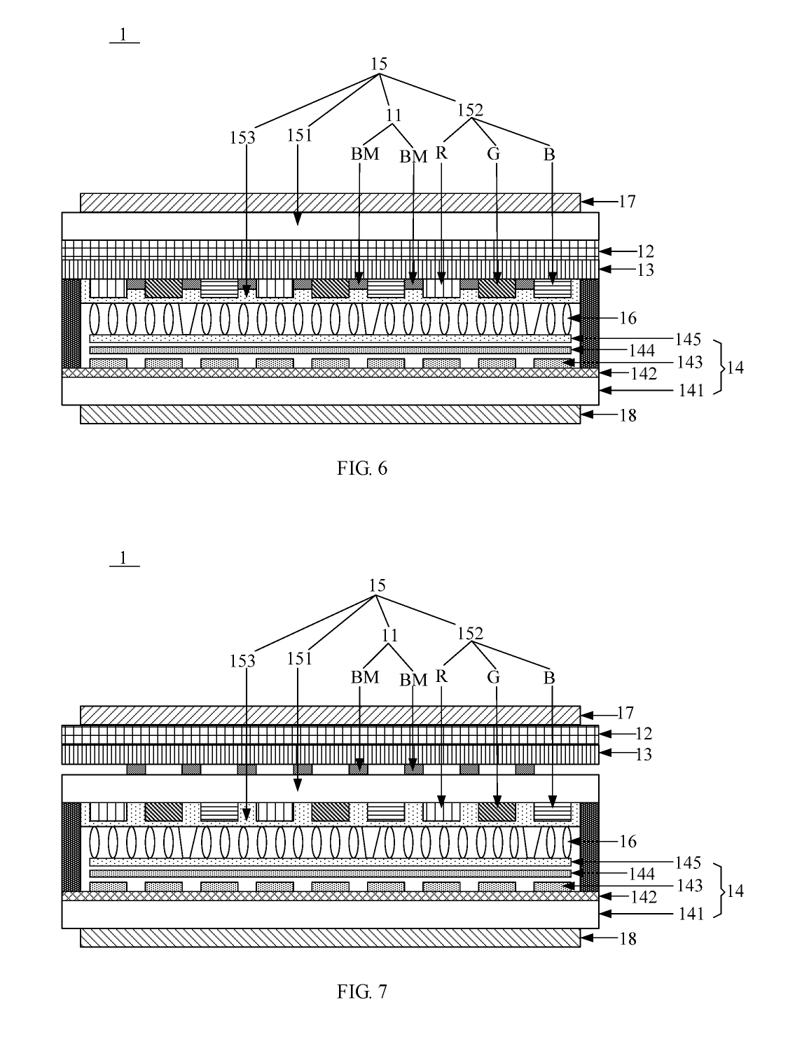

Optionally, in one embodiment of the present disclosure, as shown in FIG. 6, the touch electrode layer 12, the black matrix pattern 11 and the color filter layer 152 are disposed at one side of the base substrate 151 facing away from the light emitting surface of the touch display screen 1, and the touch electrode layer 12 is disposed between the base substrate 151 and the light converting layer 13. In other words, as can be seen from FIG. 6, the touch electrode layer 12 is disposed at one side of the base substrate 151 adjacent the liquid crystal layer 16, the light converting layer 13 is disposed on the touch electrode layer 12, the black matrix pattern 11 is disposed on the light converting layer 13, the color filter layer 152 is disposed on the black matrix pattern 11, and the alignment layer 153 is disposed on the color filter layer 152. Alternatively, the touch electrode layer 12 is disposed at one side of the base substrate 151 adjacent the liquid crystal layer 16, the light converting layer 13 is disposed on the touch electrode layer 12, the color filter layer 152 is disposed on the light converting layer 13, the black matrix pattern 11 is disposed on the color filter layer 152, and the alignment layer 153 is disposed on the black matrix pattern 11, which are not specifically limited.

Optionally, in one embodiment of the present disclosure, as shown in FIG. 7, the color filter layer 152 is disposed at one side of the base substrate 151, the touch electrode layer 12, the light converting layer 13 and the black matrix pattern 11 are disposed at one side of the base substrate 151 facing away from the color filter layer 152, and the black matrix pattern 11 is disposed between the base substrate 151 and the light converting layer 13. In other words, as can be seen from FIG. 7, the color filter layer 152 is disposed at one side of the base substrate 151 adjacent the liquid crystal layer 16, the alignment layer 153 is disposed on the color filter layer 152, the black matrix pattern 11 is disposed on one side of the base substrate 151 facing away from the color filter layer 152, an orthographic projection of the color filter layer 152 on one surface of the base substrate 151 facing away from the color filter layer 152 is in the opening regions of the black matrix pattern 11, the light converting layer 13 is disposed on the black matrix pattern 11, the touch electrode layer 12 is disposed on the light converting layer 13, and the first polarizer 17 is disposed on the touch electrode layer 12, which are not specifically limited.

Optionally, in one embodiment of the present disclosure, the light converting layer 13 may include prim structures. Optionally, the light converting layer 13 may be made of acrylic resin. The light converting layer 13 is used to convert distracted light rays that pass through the black matrix pattern into parallel light rays which are perpendicular to the light emitting surface of the touch display screen 1. The light converting layer 13 may be a prim layer which includes a prim sheet. The prim sheet can also be referred as brightness enhancement film (BEF). The brightness enhancement film is an optical thin film which is formed by using 3M micro-replication technology to provide prim structures made of acrylic resin on a substrate which is made of polyethylene terephthalate (PET). Micro-prism structures with a height in a range of from 20 um to 50 um are formed at a surface of the brightness enhancement film, and can convert light rays according to the principle of geometric optics, thereby enabling a direction of the light rays to be perpendicular to the light emitting surface of the touch display screen 1.

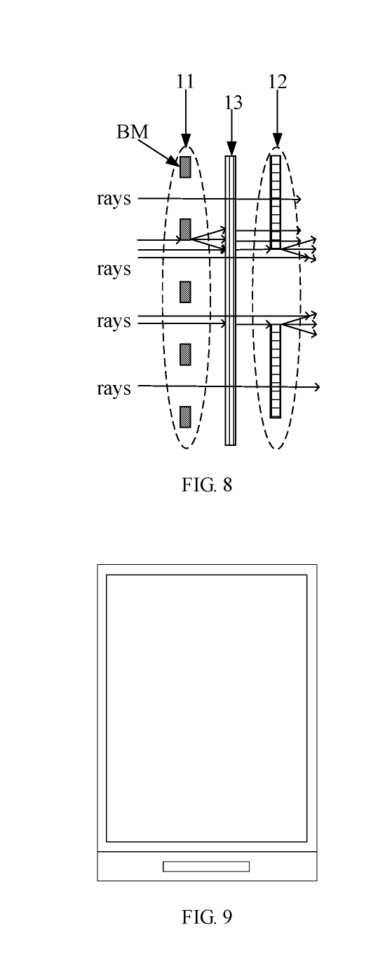

FIG. 8 is a schematic diagram showing that light diffraction and light interference occurring at the touch display screen 1 according to an embodiment of the present disclosure. Referring to FIG. 8, when light rays pass through the black matrix pattern 11, the black matrices BM can block the light rays, but the light rays may pass through the black matrix pattern 11 through the opening regions between adjacent black matrices BM. Light rays which pass through the black matrix pattern at a position close to an end of the black matrix BM, are diffracted and change their previous direction. Since the diffracted light rays change their direction, the diffracted light rays will interfere with light rays that are not diffracted. Light rays that undergo interference are then incident to the light converting layer 13. The light converting layer 13 converts the light rays into parallel light rays. The parallel light rays emitted from the light converting layer 13 are then incident to the touch electrode layer 12. The parallel light rays will be diffracted and interfered by the touch electrode pattern of the touch electrode layer 12. A direction of the parallel light rays is perpendicular to the light emitting surface of the touch display screen (not shown in FIG. 8). Since the parallel light rays rather than light rays that undergo diffraction and interference, are incident to the touch electrode layer 12, when the light rays pass through the touch display screen, the light rays undergo two independent diffraction and interference rather than two superimposed diffraction and interference. In this case, a period of an interference pattern is relative small and is imperceptible to human eyes, and thus no visible undesirable pattern appears on the touch display screen. For example, FIG. 9 is a schematic view of a display device (not labeled) which includes the touch display screen according to an embodiment of the present disclosure. Referring to FIG. 9, no visible undesirable pattern appears on the touch display screen.

It should be noted that, in the touch display screen 1 shown in FIG. 4 to FIG. 7, the common electrode and the pixel electrode both are on the array substrate and are arranged in different layers. This type of touch display screen may be referred as advanced-super dimensional switching (ADS) type touch display screen. FIG. 4 to FIG. 7 of the present disclosure are just exemplary. In actual application, the touch display screen 1 may also be in plane switch (IPS) type touch display screen, or twist nematic (TN) type touch display screen or the like, which are not limited in the present disclosure.

In the IPS type touch display screen, the common electrode and the pixel electrode both are on the array substrate and are arranged in the same layer. The common electrode includes a plurality of first strip electrodes, and the pixel electrode includes a plurality of second strip electrodes. The first strip electrodes and the second strip electrodes are spaced from each other. In the TN type touch display screen, the common electrode is disposed on the color substrate, and the pixel electrode is disposed on the array substrate. Here, “arranged in the same layer” refers to at least two patterns, and “at least two patterns arranged in the same layer” means that the at least two patterns are formed from an identical film by using patterning process. For example, that the common electrode and the pixel electrode are arranged in the same layer means that the common electrode and the pixel electrode are formed from an identical conductive film by using patterning process. Here, “arranged in different layers” refers to at least two patterns, and “at least two patterns arranged in different layers” means that the at least two patterns are respectively formed from at least two films by using patterning process. “Two patterns arranged in different layers” means that each of two films is formed into one pattern by the using patterning process. For example, that the common electrode and the pixel electrode are arranged in different layers means that a lower electrode is formed from a first conductive film by the using patterning process and an upper electrode is formed from a second conductive film by the using patterning process. The lower electrode is a common electrode (or pixel electrode), and the upper electrode is a pixel electrode (or common electrode). The pixel electrode refers to an electrode which is electrically connected to a data line through a switching unit (such as a thin film transistor). The common electrode is an electrode which is electrically connected with a common electrode line, which will not be elaborated herein.

In conclusion, in the touch display screen of one embodiment of the present disclosure, since the light converting layer is able to convert diffracted light rays that pass through the black matrix pattern into parallel light rays, the light converting layer can prevent the light from undergoing two superimposed diffraction and interference before emitting from the touch display screen, thereby avoiding appearance of the visible undesirable moire patterns on the touch display screen, solving the problem of appearance of the visible undesirable moiré patterns on the touch display screen in the related art, and then achieving effects of avoiding appearance of the visible undesirable moiré patterns on the touch display screen.

The touch display screen of one embodiment of the present disclosure is mainly applied to a touch liquid crystal display device. Since the light converting layer is disposed between the black matrix pattern and the touch electrode layer to convert light rays, so that distracted light rays and interfered light rays that pass through the black matrix pattern are converted into parallel light rays. Then the parallel light rays pass through the touch electrode layer. The parallel light rays are distracted by the touch electrode pattern when the parallel light rays pass through the touch electrode layer, and enter into the human eyes. Since the light converting layer is able to convert distracted light rays and interfered light rays into parallel light rays, then the parallel light rays are distracted and interfered and then enters into the human eyes. Thus, the light rays that eventually enter the human eye are equivalent to light rays that undergo diffraction and interference for only one time. The period of diffraction and interference for a single layer is small, and thus is imperceptible to the human eyes, thereby suppressing undesirable moiré patterns of on cell products and improving product yield.

The touch display screen of one embodiment of the present disclosure can be applied to the following method. A method for manufacturing the touch display screen and its manufacturing principle of one embodiment of the present disclosure can be referred to descriptions of the following embodiments.

One embodiment of the present disclosure further provides a method for manufacturing a touch display screen. The method can be used to manufacture the touch display screen 1 as shown in any one of FIG. 2 to FIG. 7. The method includes: forming a black matrix pattern, a touch electrode layer and a light converting layer in such a manner that the light converting layer is disposed between the black matrix pattern and the touch electrode layer. The light converting layer is used to convert diffracted light rays that pass through the black matrix pattern into parallel light rays, and the parallel light rays pass through the touch electrode layer and are emitted from the touch display screen.

Optionally, the touch display screen includes a color filter substrate. The color filter substrate includes a base substrate, a black matrix pattern and a color filter layer disposed in opening regions of the black matrix pattern.

Optionally, forming a black matrix pattern, a touch electrode layer and a light converting layer in such a manner that the light converting layer is disposed between the black matrix pattern and the touch electrode layer includes: forming the light converting layer at one side of the base substrate; forming the black matrix pattern and the color filter layer on the light converting layer in such a manner that the color filter layer is disposed in the opening regions of the black matrix pattern; and forming the touch electrode layer on one side of the base substrate facing away from the black matrix pattern.

Optionally, forming a black matrix pattern, a touch electrode layer and a light converting layer in such a manner that the light converting layer is disposed between the black matrix pattern and the touch electrode layer includes: forming the black matrix pattern and the color filter layer on one side of the base substrate in such a manner that the color filter layer is disposed in the opening regions of the black matrix pattern; forming the light converting layer on one side of the base substrate facing away from the black matrix pattern; and forming the touch electrode layer on the light converting layer.

Optionally, forming a black matrix pattern, a touch electrode layer and a light converting layer in such a manner that the light converting layer is disposed between the black matrix pattern and the touch electrode layer includes: forming the touch electrode layer on one side of the base substrate; forming the light converting layer on the touch electrode layer; and forming the black matrix pattern and the color filter layer on the light converting layer in such a manner that the color filter layer is disposed in the opening regions of the black matrix pattern.

Optionally, forming a black matrix pattern, a touch electrode layer and a light converting layer in such a manner that the light converting layer is disposed between the black matrix pattern and the touch electrode layer includes: forming the color filter layer on one side of the base substrate; and forming the touch electrode layer, the light converting layer and the black matrix pattern on one side of the base substrate facing away from the color filter layer in such a manner that the black matrix pattern is disposed between the base substrate and the light converting layer.

Optionally, the light converting layer includes prism structures, which are used to convert distracted light rays that pass through the black matrix pattern into parallel light rays which are perpendicular to the light emitting surface of the touch display screen.

Optionally, the touch display screen further includes an array substrate and a liquid crystal layer disposed between the array substrate and the color filer substrate, and the array substrate and the color substrate are oppositely arranged with respect to each other to define a cell. The method further includes: oppositely arranging the array substrate with respect to the color filter substrate to define a cell in such a manner that the liquid crystal layer is disposed between the array substrate and the color filer substrate and the color filer layer is on one side of the base substrate of the color filter substrate adjacent the liquid crystal layer; forming a first polarizer on one side of the base substrate facing away from the liquid crystal layer; forming a second polarizer on one side of the array substrate facing away from the liquid crystal layer in such a manner that a polarization direction of the first polarizer is perpendicular to a polarization direction of the second polarizer.

All of the above optional technical solutions may be arbitrarily combined to form optional embodiments of the present disclosure, which will not be elaborated herein.

In conclusion, according to the method for manufacturing a touch display screen of one embodiment of the present disclosure, since the light converting layer is able to convert diffracted light rays that pass through the black matrix pattern into parallel light rays, the light converting layer can prevent the light rays from undergoing two superimposed diffraction and interference before emitting from the touch display screen, thereby avoiding appearance of the visible undesirable moiré patterns on the touch display screen, solving the problem of appearance of the visible undesirable moiré patterns on the touch display screen in the related art, and then achieving effects of avoiding appearance of the visible undesirable moiré patterns on the touch display screen.

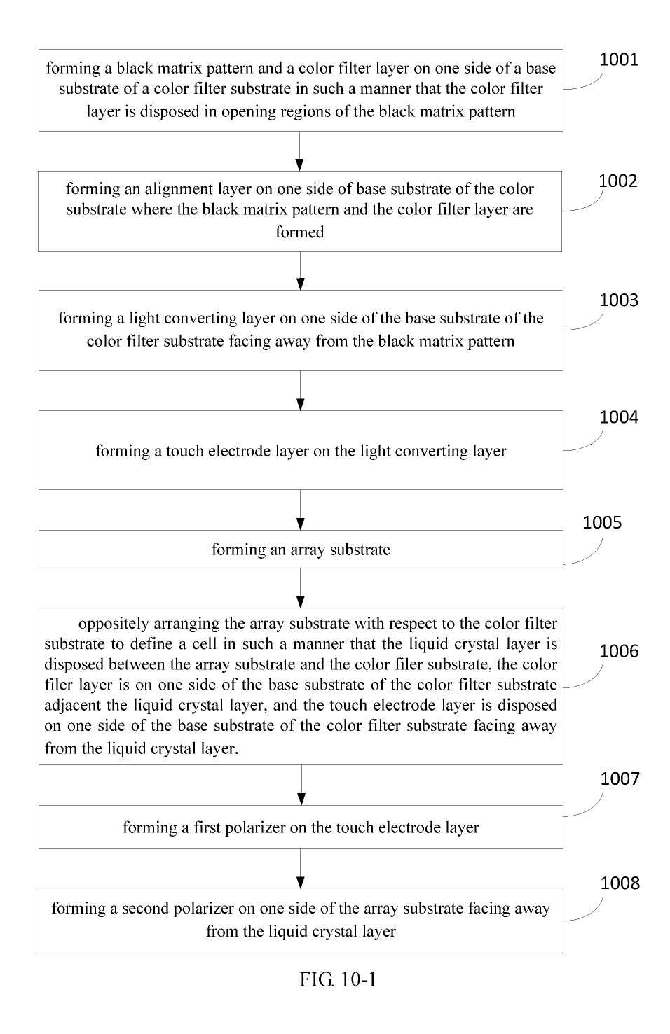

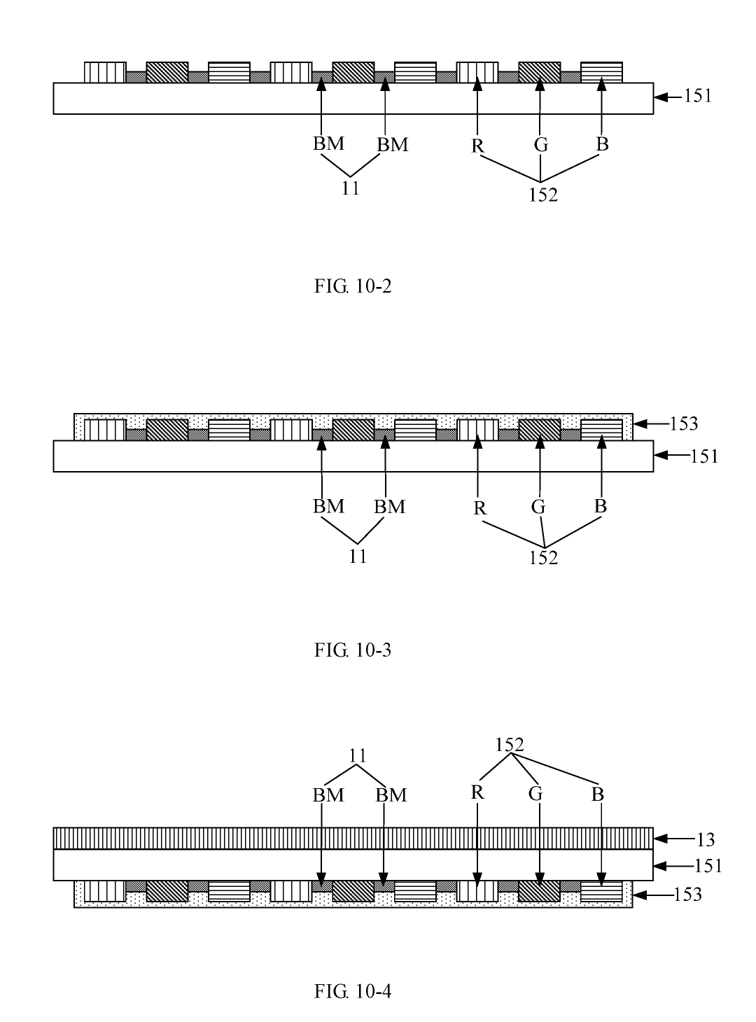

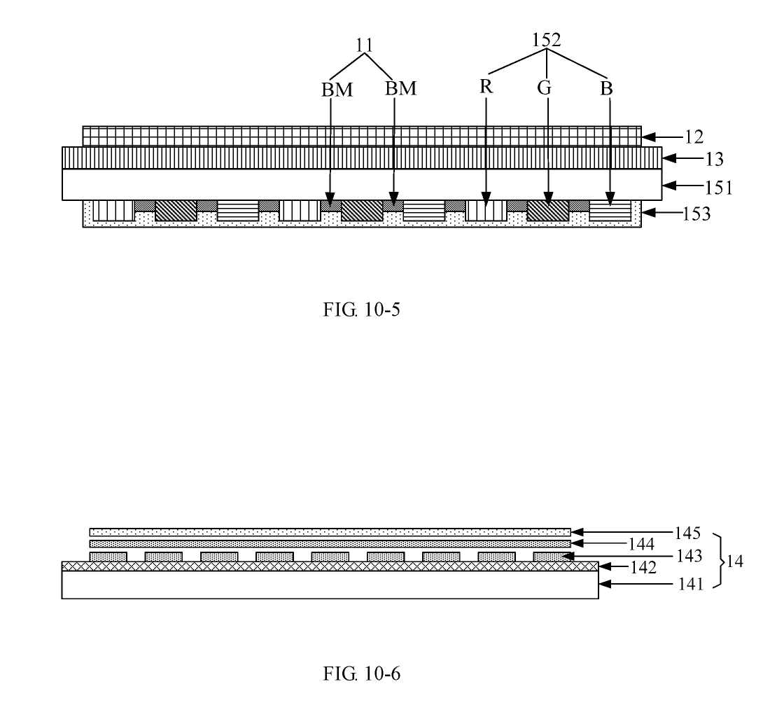

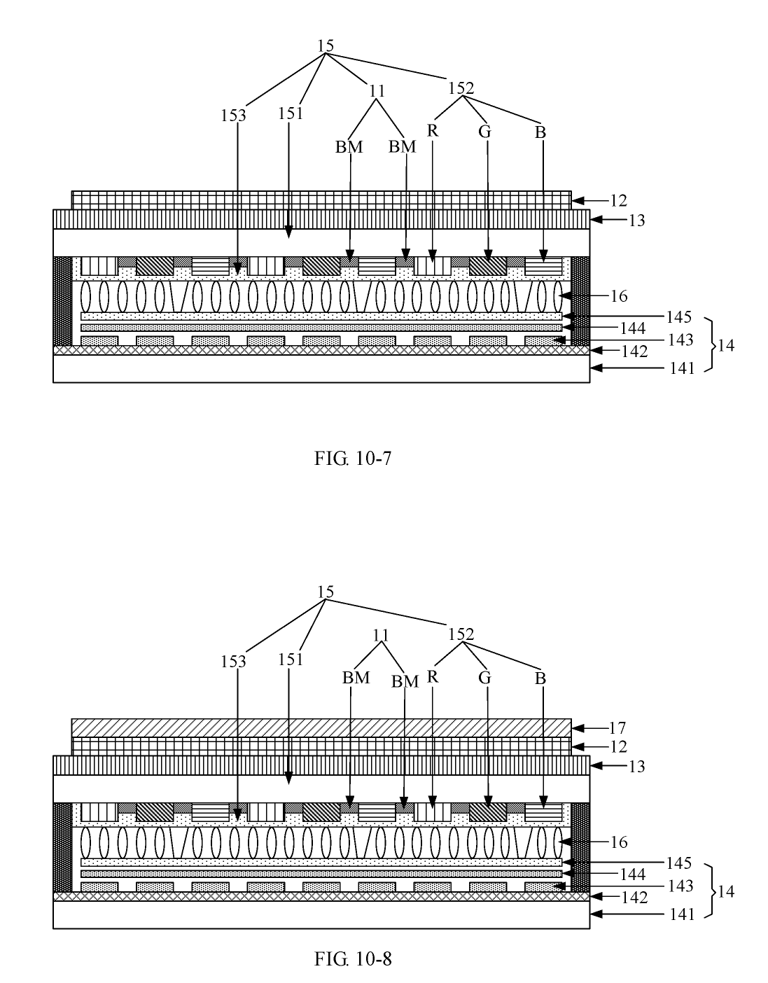

FIG. 10-1 is a flow chart of a method for manufacturing a touch display screen according to an embodiment of the present disclosure. Referring to FIG. 10-1, the method can be used to manufacture the touch display screen 1 as shown in any of FIG. 2 to FIG. 7. The method will be described by taking manufacture of the touch display screen 1 shown in FIG. 5 as an example. Referring to FIG. 10-1, the method includes the following steps.

Step 1001 is to form a black matrix pattern and a color filter layer on one side of a base substrate of a color filter substrate in such a manner that the color filter layer is disposed in opening regions of the black matrix pattern.

FIG. 10-2 is a schematic view showing a structure obtained by forming a black matrix pattern 11 and a color filter layer 152 on one side of a base substrate 151 of a color filter substrate according to the embodiment shown in FIG. 10-1. Referring to FIG. 10-2,

The black matrix pattern 11 is a network structure which is composed of crisscrossed black matrices BM. The color filter layer 152 is disposed in opening regions (not labeled) of the black matrix pattern 11. The color filter layer 152 includes a color filter pattern composed of a plurality of color filter units which are arranged in an array. One black matrix BM is disposed between any two adjacent color filter units. The color filter units may include red color filter units R, green color filter units G and blue color filter units B. The number of each type of the color filter units may be more than one. Thickness of the black matrix BM and thickness of the color filter unit may be set according to actual needs, which are not limited herein. The red color filer unit R may be made of red resin material, the green color filer unit G may be made of green resin material, the blue color filer unit B may be made of blue resin material, and the black matrix pattern 11 may be made of black resin material.

In one embodiment of the present disclosure, the black matrix pattern 11 may be made of black resin material through a one-time patterning process. Then, the color filter layer 152 is formed by performing three times of patterning process with resin material of corresponding colors. For example, when forming the black matrix pattern 11, one layer of black resin material is deposited on one side of the base substrate 151 of the color filter substrate through coating, magnetron sputtering, thermal evaporation or plasma enhanced chemical vapor deposition (PECVD) or the like, thereby obtaining a black resin layer, and then the black matrix pattern 11 is obtained by performing one-time patterning process to the black resin layer. When forming the color filter layer 152, one layer of red resin material is deposited on one side of the base substrate 151 of the color filter substrate where the black matrix pattern 11 is formed through coating, magnetron sputtering, thermal evaporation or plasma enhanced chemical vapor deposition (PECVD) or the like, thereby obtaining a red resin layer, and one-time patterning process is performed to the red resin layer to obtain the red color filter units R. Then, one layer of green resin material is deposited on one side of the base substrate 151 of the color filter substrate where the red color filter units R are formed through coating, magnetron sputtering, thermal evaporation or plasma enhanced chemical vapor deposition (PECVD) or the like, thereby obtaining a green resin layer, and one-time patterning process is performed to the green resin layer to obtain the green color filter units G Subsequently, one layer of blue resin material is deposited on one side of the base substrate 151 of the color filter substrate where the green color filter units G are formed through coating, magnetron sputtering, thermal evaporation or plasma enhanced chemical vapor deposition (PECVD) or the like, thereby obtaining a blue resin layer, and one-time patterning process is performed to the blue resin layer to obtain the blue color filter units B. To this point, the color filter layer 152 is obtained.

The one-time patterning process includes: coating photoresist, exposing, developing, etching and stripping of photoresist, performing one-time patterning process to the red resin layer include: coating a layer of photoresist on the red resin layer, exposing the photoresist with a mask to form a first region where the photoresist is completely exposed and a second region where the photoresist is partially exposed, removing the photoresist in the first region by means of developing process with the photoresist in the second region remained, etching portions of the read resin in such a manner that the portions are corresponding to the first region, and stripping off the photoresist in unexposed regions to obtain the red color filter units R. It should be noted that the above description takes using positive photoresist to form the red color filter units R as an example, in actual applications, negative photoresist may be used to form the red color filter units R. The process of performing one-time patterning process to one of the green resin layer, the blue resin layer and the black resin layer is similar to the process of performing one-time patterning process to the red resin layer, and will be not elaborated herein.

It should be noted that the above embodiment is described with an example in which the black matrix pattern 11 is first formed and then the color filter layer 152 is formed. In actual application, the color filter layer 152 may be formed first and then the black matrix pattern 11 is formed. Further, the above process of forming the color filter units of the color filter layer 152 may be adjusted. For example, the red color filter units R may be first formed, then the green color filter units G may be formed, and finally the blue color filter units B are formed; or, the green color filter units G may be formed first, then the red color filter units R may be formed, and finally the blue color filter units B are formed; or, the red color filter units R, the green color filter units G and the blue color filter units B may be formed in other order. In addition, in some embodiments, the red color filter units R, the green color filter units G and the blue color filter units B may be formed through one-time patterning process, which will be not elaborated herein.

Step 1002 is to form an alignment layer on one side of base substrate of the color substrate where the black matrix pattern and the color filter layer are formed.

FIG. 10-3 is a schematic view of a structure obtained by form the alignment layer 153 on one side of the base substrate 151 of the color substrate where the black matrix pattern 11 and the color filter layer 152 are formed according to the embodiment in FIG. 10-1. Referring to FIG. 10-3, the alignment layer 153 may be made of PI solution, and the thickness of the alignment layer 153 may be set according to actual needs. For example, a layer of PI may be coated on one side of the base substrate 151 of the color substrate where the black matrix pattern 11 and the color filter layer 152 are formed, and then is cured to obtain the alignment layer 153.

Step 1003 is to form a light converting layer on one side of the base substrate of the color filter substrate facing away from the black matrix pattern.

FIG. 10-4 is a schematic view of a structure obtained by forming a light converting layer 13 on one side of the base substrate 151 of the color filter substrate facing away from the black matrix pattern 11 according to the embodiment in FIG. 10-1. Referring to FIG. 10-4, the light converting layer 13 may be disposed on the base substrate 151 and is used to convert distracted light rays into parallel light rays.

In one embodiment of the present disclosure, the light converting layer 13 may be fabricated by taking the base substrate 151 of the color filter substrate as a base, or the light converting layer 13 may be fabricated first and then is attached to the base substrate 151, which are not limited in the present disclosure.

The light converting layer 13 includes prism structures which may be made of acrylic resin. The light converting layer 13 may be a prim layer which includes a prim sheet. The prim sheet can also be referred as brightness enhancement film (BEF). The brightness enhancement film is an optical thin film which is formed by using 3M micro-replication technology to provide prim structures made of acrylic resin on a substrate which is made of polyethylene terephthalate (PET). Micro-prism structures with a height in a range of from 20 um to 50 um are formed at a surface of the brightness enhancement film, and can convert light rays according to the principle of geometric optics. Thus, when the light converting layer 13 is a prism layer, the light converting layer 13 may be attached to the base substrate 151. For example, the light converting layer 13 may be attached to the base substrate 151 through optically clear adhesive (OCA), which will not be elaborated herein.

Step 1004 is to form a touch electrode layer on the light converting layer.

FIG. 10-5 is a schematic view of a structure obtained by forming a touch electrode layer 12 on the light converting layer 13 according to the embodiment in FIG. 10-1. Referring to FIG. 10-5, the touch electrode layer 12 includes a touch electrode pattern (not shown in FIG. 10-5) which is composed of a plurality of touch electrodes arranged in a matrix. The touch electrodes may include touch-emitting electrodes and touch-receiving electrodes. The touch electrodes may be strip electrodes, or bar electrodes or the like. The touch electrodes may be made of semiconductor oxide such as indium tin oxide (ITO) and indium zinc oxide (IZO), and the thickness of the touch electrodes 12 may be set according to actual needs, which are not limited herein.

For example, a layer of ITO material is deposited on the light converting layer 13 through coating, magnetron sputtering, thermal evaporation or plasma enhanced chemical vapor deposition (PECVD) or the like, thereby obtaining an ITO layer. Then, one-time patterning process is performed to the ITO layer to obtain the touch electrode pattern, thereby obtaining the touch electrodes 12. The process of performing one-time patterning process to the ITO layer may refer to the process of performing one-time patterning process to the red resin layer in the step 1001, which will be not elaborated herein.

Step 1005 is to form an array substrate.

FIG. 10-6 is a schematic view of an array substrate 14 according to the embodiment in FIG. 10-1. Referring to FIG. 10-6, the array substrate 14 includes a base substrate 141, a metal wiring lay 142, first electrodes 143, a second electrode 144 and an alignment layer 145. The metal wiring layer 142, the first electrodes 143, the second electrode 144 and the alignment layer 145 are sequentially arranged on the base substrate 141. In FIG. 10-6, each of one portion between the first electrodes 143 and the second electrode 144 and one portion between the second electrode 144 and the alignment layer 145 may be an insulation layer. The process of forming the array substrate 14 may refer to relevant technology, which will not be elaborated herein.

Step 1006 is to oppositely arrange the array substrate with respect to the color filter substrate to define a cell in such a manner that the liquid crystal layer is disposed between the array substrate and the color filer substrate, the color filer layer is on one side of the base substrate of the color filter substrate adjacent the liquid crystal layer, and the touch electrode layer is disposed on one side of the base substrate of the color filter substrate facing away from the liquid crystal layer.

FIG. 10-7 is a schematic view of a structure obtained by oppositely arranging the array substrate 14 with respect to the color filter substrate 15 to define a cell according to the embodiment in FIG. 10-1. Referring to FIG. 10-7, the liquid crystal layer 16 is disposed between the array substrate 14 and the color filter substrate 15. The black matrix pattern 11 and the color filter layer 152 are disposed on one side of the base substrate 151 of the color filter substrate 15 adjacent the liquid crystal layer 16. A sealant frame (not labeled in FIG. 10-7) is disposed between the base substrate 151 of the color filter substrate 15 and the base substrate 141 of the array substrate 14. An orthographic projection of the sealant frame on the array substrate 14 is in a non-display region (not labeled in FIG. 10-7) of the array substrate 14. An orthographic projection of the sealant frame on the color filter substrate 15 is in a non-display region (not labeled in FIG. 10-7) of the color filter substrate 15.

For example, the sealant frame may be formed on one surface of the base substrate 141 where the metal wiring layer 142, the first electrodes 143, the second electrode 144 and the alignment layer 145 are formed, and are in the non-display region of the array substrate 14. Then, liquid crystals are dropped into a space enclosed by the sealant frame through the dropping process. Subsequently, one surface of the color filter substrate 15 where the color filter layer 152 is formed, is oppositely arranged with and attached to one surface of the array substrate 14 where the metal wiring layer 142 is formed, thereby oppositely arranging the array substrate with respect to the color filter substrate to define a cell.

Step 1007 is to form a first polarizer on the touch electrode layer.

FIG. 10-8 is a schematic view of a structure obtained by forming a first polarizer 17 on the touch electrode layer 12 according to the embodiment in FIG. 10-1. The first polarizer 17 may be directly formed on the touch electrode layer 12 by taking the touch electrode layer 12 as a base, or, the first polarizer 17 may be separately formed and is then attached to the touch electrode layer 12. The process of directly forming the first polarizer 17 on the touch electrode layer 12 by taking the touch electrode layer 12 as a base and the process of attaching the first polarizer 17 to the touch electrode layer 12 may refer to the relevant technology, which will not be elaborated herein.

Step 1008 is to form a second polarizer on one side of the array substrate facing away from the liquid crystal layer.

A schematic view of a structure obtained by forming a second polarizer 18 on one side of the array substrate 14 facing away from the liquid crystal layer 16 is shown in FIG. 5. A polarization direction of the first polarizer 17 may be perpendicular to a polarization direction of the second polarizer 18, thereby enabling light rays to be able to pass through the touch display screen. The process of forming the second polarizer 18 on one side of the array substrate 14 facing away from the liquid crystal layer 16, is similar to the process of forming the first polarizer 17 on the touch electrode layer 12 in the step 1007.

It should be noted that, the sequence of steps of the method for manufacturing touch display screens can be adjusted appropriately, and the steps may be reduced or increased according to situations. For example, the above steps 1003 and 1004 may be between the step 1006 and the step 1007, or the above step 1007 may be between the above step 1004 and the step 1005.

It also should be noted that, this embodiment is described by taking manufacture of the touch display screen 1 shown in FIG. 5 as an example, and a method for manufacturing the touch display screen 1 shown in FIG. 2, FIG. 4, FIG. 6 and Fi. 7 is similar to the above method, which will not be elaborated herein.

In conclusion, according to the method for manufacturing a touch display screen of one embodiment of the present disclosure, since the light converting layer is able to convert diffracted light rays that pass through the black matrix pattern into parallel light rays, the light converting layer can prevent the light rays from undergoing two superimposed diffraction and interference before emitting from the touch display screen, thereby avoiding appearance of the visible undesirable moiré patterns on the touch display screen, solving the problem of appearance of the visible undesirable moiré patterns on the touch display screen in the related art, and then achieving effects of avoiding appearance of the visible undesirable moiré patterns on the touch display screen.

One embodiment of the present disclosure further provides a touch display device which includes the touch display screen shown in any one of FIG. 2 to FIG. 7. The touch display device may be a smart phone, a tablet computer, an intelligent vehicle terminal, or the like.

In conclusion, in the touch display device of one embodiment of the present disclosure, since the light converting layer is able to convert diffracted light rays that pass through the black matrix pattern into parallel light rays, the light converting layer can prevent the light from undergoing two superimposed diffraction and interference before emitting from the touch display screen, thereby avoiding appearance of the visible undesirable moiré patterns on the touch display screen, solving the problem of appearance of the visible undesirable moiré patterns on the touch display screen in the related art, and then achieving effects of avoiding appearance of the visible undesirable moiré patterns on the touch display screen.

The methods described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, ROM or other proper storage device. Or, at least part of the machine-readable instructions may be substituted by specific-purpose hardware, such as custom integrated circuits, gate array, FPGA, PLD and specific-purpose computers and so on.

The above are merely the preferred embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

What is claimed is:

1. A touch display screen comprising:
a black matrix pattern;
a touch electrode layer; and
a light converting layer;
wherein the light converting layer is between the black matrix pattern and the touch electrode layer and is configured to convert diffracted light rays that pass through the black matrix pattern into parallel light rays which pass through the touch electrode layer to emit from the touch display screen.

2. The touch display screen of claim 1, further comprising a color filter substrate; wherein the color filter substrate includes a base substrate, the black matrix pattern and a color filter layer in opening regions of the black matrix pattern.

3. The touch display screen of claim 2, wherein the black matrix pattern and the color filter layer are on an identical side of the base substrate, and the touch electrode layer is on one side of the base substrate facing away from the black matrix pattern.

4. The touch display screen of claim 3, wherein the light converting layer is between the base substrate and the black matrix pattern, and the black matrix pattern is between the light converting layer and the color filter layer; or
the light converting layer is between the base substrate and the color filter layer, and the color filter layer is between the light converting layer and the black matrix pattern.

5. The touch display screen of claim 3, wherein the light converting layer is between the base substrate and the touch electrode layer.

6. The touch display screen of claim 2, wherein the touch electrode layer, the black matrix pattern and the color filter layer are at one side of the base substrate facing away from a light emitting surface of the touch display screen, and the touch electrode layer is between the base substrate and the light converting layer.

7. The touch display screen of claim 2, wherein the color filter layer is at one side of the base substrate, the touch electrode layer, the light converting layer and the black matrix pattern are at one side of the base substrate facing away from the color filter layer, and the black matrix pattern is between the base substrate and the light converting layer.

8. The touch display screen of claim 1, wherein the light converting layer includes prim structures which are configured to convert the distracted light rays that pass through the black matrix pattern into parallel light rays which are perpendicular to a light emitting surface of the touch display screen.

9. A method for manufacturing a touch display screen, comprising:
forming a black matrix pattern, a touch electrode layer and a light converting layer in such a manner that the light converting layer is between the black matrix pattern and the touch electrode layer;
wherein the light converting layer is configured to convert diffracted light rays that pass through the black matrix pattern into parallel light rays which pass through the touch electrode layer to emit from the touch display screen.

10. The method of claim 9, wherein the touch display screen includes a color filter substrate; the color filter substrate includes a base substrate, the black matrix pattern and a color filter layer in opening regions of the black matrix pattern.

11. The method of claim 10, wherein forming a black matrix pattern, a touch electrode layer and a light converting layer in such a manner that the light converting layer is disposed between the black matrix pattern and the touch electrode layer includes:
forming the light converting layer at one side of the base substrate;
forming the black matrix pattern and the color filter layer on the light converting layer in such a manner that the color filter layer is in the opening regions of the black matrix pattern; and
forming the touch electrode layer on one side of the base substrate facing away from the black matrix pattern.

12. The method of claim 10, wherein forming a black matrix pattern, a touch electrode layer and a light converting layer in such a manner that the light converting layer is disposed between the black matrix pattern and the touch electrode layer includes:
forming the black matrix pattern and the color filter layer on one side of the base substrate in such a manner that the color filter layer is in the opening regions of the black matrix pattern;
forming the light converting layer on one side of the base substrate facing away from the black matrix pattern; and
forming the touch electrode layer on the light converting layer.

13. The method of claim 10, wherein forming a black matrix pattern, a touch electrode layer and a light converting layer in such a manner that the light converting layer is disposed between the black matrix pattern and the touch electrode layer includes:
forming the touch electrode layer on one side of the base substrate;
forming the light converting layer on the touch electrode layer; and
forming the black matrix pattern and the color filter layer on the light converting layer in such a manner that the color filter layer is in the opening regions of the black matrix pattern.

14. The method of claim 10, wherein forming a black matrix pattern, a touch electrode layer and a light converting layer in such a manner that the light converting layer is disposed between the black matrix pattern and the touch electrode layer includes:
forming the color filter layer on one side of the base substrate; and
forming the touch electrode layer, the light converting layer and the black matrix pattern on one side of the base substrate facing away from the color filter layer in such a manner that the black matrix pattern is between the base substrate and the light converting layer.

15. A touch display device comprising the touch display screen of claim 1.
